(19) United States
(12) Patent Application Publication
(10) Pub. No.: US 2025/0249771 A1
(43) Pub. Date: Aug. 7, 2025

(54) CHARGING SYSTEM

(71) Applicant: TOYOTA JIDOSHA KABUSHIKI KAISHA, Toyota-shi (JP)

(72) Inventor: Yoichi ONISHI, Okazaki-shi (JP)

(73) Assignee: TOYOTA JIDOSHA KABUSHIKI KAISHA, Toyota-shi (JP)

(21) Appl. No.: 18/937,049

(22) Filed: Nov. 5, 2024

(30) Foreign Application Priority Data
Feb. 5, 2024 (JP) 2024-015877

(51) Int. Cl. B60L 53/302; B60L 53/60; H02J 7/00

(52) U.S. Cl. CPC B60L 53/302; B60L 53/60; H02J 7/00309; H02J 7/007192

(57) ABSTRACT

A charging system includes a charging device that charges a battery mounted on a vehicle and is installed in a room, and a control device that controls the charging device to limit electric power supplied to the battery when a temperature of the charging device becomes equal to or higher than a threshold. The charging system includes: a selection device that receives selection of one of a first air-conditioning mode where a temperature inside the room is set to a temperature that prioritizes comfort of a user in the room over a battery charging time with the charging device, and a second air-conditioning mode where the temperature inside the room is set to a temperature that prioritizes the charging time over the comfort; and an air-conditioning device that is installed in the room with the charging device and air-conditions the room in the air-conditioning mode selected by the selection device.

### CROSS-REFERENCE TO RELATED APPLICATION

This application claims priority to Japanese Patent Application No. 2024-015877 filed on Feb. 5, 2024, incorporated herein by reference in its entirety.

### BACKGROUND

### 1. Technical Field

The present disclosure relates to a charging system.

### 2. Description of Related Art

As a charging system of this type, there has been conventionally proposed a charging system including a charging device that charges a battery mounted on a vehicle and is installed in a room (storage building) (for example, see Japanese Unexamined Patent Application Publication No. 2012-533978 (JP 2012-533978 A)). In this system, an air-conditioning device that controls a temperature inside the room is provided.

### SUMMARY

In general, in the above-described charging system, when a temperature of the charging device becomes equal to or higher than a predetermined temperature, the electric power supplied to the battery is limited such that a temperature rise of the charging device is suppressed, thereby protecting the charging device. When the electric power supplied from the charging device to the battery is limited, it takes a relatively long time to charge the battery, causing a reduction in the charging efficiency. In order to suppress a reduction in the charging efficiency, it is conceivable that the temperature inside the room is lowered by the air-conditioning device to cool the charging device, so that the temperature of the charging device is lower than a predetermined temperature. However, when the temperature inside the room is set low, in a case where a user such as an owner of the vehicle is in the room, the comfort is reduced, and the convenience of the user is reduced.

A main object of a charging system of the present disclosure is to suppress a reduction in convenience of a user.

In the charging system of the present disclosure, the following solutions are employed to achieve the above-described main object.

A charging system of the present disclosure is a charging system including a charging device that charges a battery mounted on a vehicle and is installed in a room, and a control device that controls the charging device such that electric power supplied to the battery is limited when a temperature of the charging device becomes equal to or higher than a threshold value. The charging system includes: a selection device that receives selection of any one of a first air-conditioning mode in which a temperature inside the room is set to a temperature that prioritizes comfort of a user in the room over a charging time for the battery with the charging device, and a second air-conditioning mode in which the temperature inside the room is set to a temperature that prioritizes the charging time over the comfort; and an air-conditioning device that is installed in the room together with the charging device and air-conditions an inside of the room in the air-conditioning mode selected by the selection device.

The charging system of the present disclosure includes the selection device that receives selection of any one of the first air-conditioning mode and the second air-conditioning mode, and the air-conditioning device that is installed in the room together with the charging device and air-conditions the inside of the room in the air-conditioning mode selected by the selection device. In the first air-conditioning mode, the temperature inside the room is set to the temperature that prioritizes the comfort of the user in the room over the charging time for the battery with the charging device. In the second air-conditioning mode, the temperature inside the room is set to the temperature that prioritizes the charging time over the comfort. This enables the user to select a desired air-conditioning mode by selecting the air-conditioning mode with the selection device. As a result, it is possible to suppress a reduction in convenience of the user.

The charging system of the present disclosure may include a temperature setting device that receives setting of a target temperature. In the first air-conditioning mode, by setting the temperature inside the room to the target temperature, the temperature inside the room may be set to the temperature that prioritizes the comfort over the charging time. In the second air-conditioning mode, by setting the temperature inside the room to be less than the threshold value, the temperature inside the room may be set to the temperature that prioritizes the charging time over the comfort. The user sets the target temperature through the temperature setting device, which makes it possible to set the temperature inside the room to the target temperature when selecting the first air-conditioning mode. This enables the user to set the temperature inside the room to a desired temperature and suppress a reduction in convenience of the user.

The charging system of the present disclosure may further include a notification device that provides notification of information. When the temperature inside the room is estimated to become less than the target temperature, the notification device may be controlled such that notification is issued to prompt selection of the air-conditioning mode by the selection device. This makes it possible to prompt the user to select the air-conditioning mode with the selection device when the temperature inside the room is estimated to become less than the target temperature.

The charging system of the present disclosure may further include a notification device that provides notification of information. In a case where the vehicle is parked in the room, the control device may control the notification device such that notification is issued to prompt selection of the air-conditioning mode by the selection device when a predetermined condition is satisfied in which the charging of the battery is estimated to be limited due to temperature rise of the battery in the vehicle. This makes it possible to, in a case where the vehicle is parked in the room, prompt the user to select the air-conditioning mode with the selection device when the charging of the battery is estimated to be limited due to the temperature rise of the battery in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of a charging system 1 according to the present embodiment;

FIG. 2 is an explanatory diagram illustrating an exemplary temperature setting window Gt displayed on the display device 26;

FIG. 3 is a flowchart illustrating an example of an air-conditioning control routine executed by the control device 28 of the charging device 20;

FIG. 4 is an explanatory diagram illustrating an exemplary of a selection reception window Gs; and

FIG. 5 is a configuration diagram illustrating an outline of a configuration of a charging system 1B according to another embodiment.

### DETAILED DESCRIPTION OF EMBODIMENTS

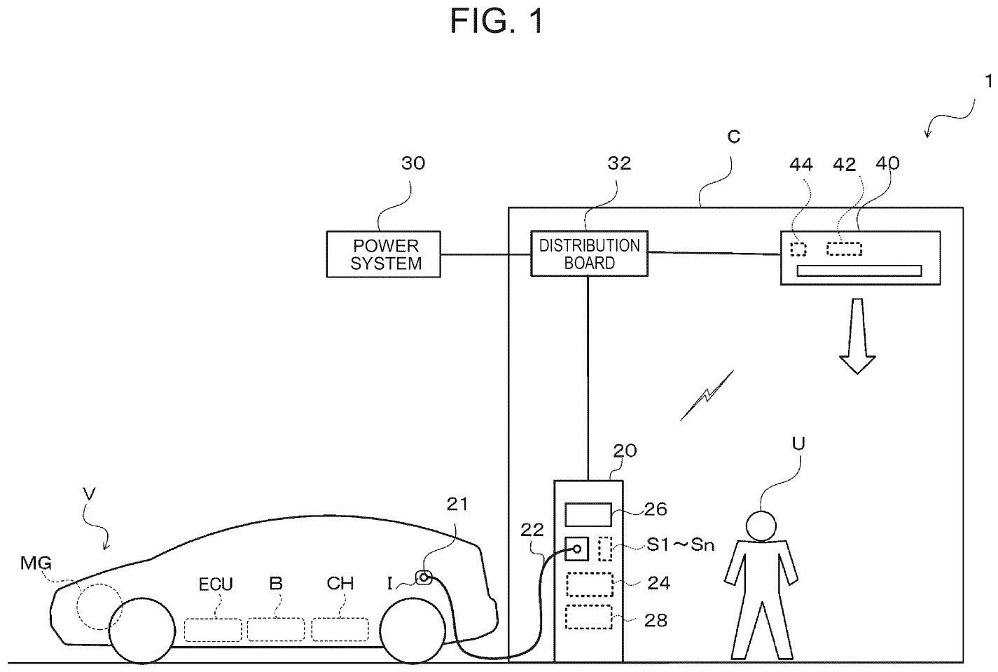

Embodiments of the present disclosure will be described with reference to the drawings. FIG. 1 is a configuration diagram schematically showing a configuration of a charging system 1 according to the present embodiment. The charging system 1 of the embodiment is configured to charge a battery B mounted on a vehicle V, and includes a charging device 20 and an air-conditioning device 40. The charging system 1 is installed in the container cabin C (indoor). The vehicle V is parked outside the container cabin C. The container cabin C also serves as a rest room for the user U of the vehicle V when the battery B is being charged.

Vehicle V is configured as a battery electric vehicle that is driven by power from the motor MG and can charge battery B with power from the outside. In addition to the motor MG and the battery B, the vehicle V includes a charger CH and an electronic control unit (charger control device) ECU. The charger CH converts the electric power supplied from the charging device 20 via the charging cable 22 into a voltage suitable for the battery B, and charges the battery B. The electronic control unit ECU includes a computer (not shown) having a CPU, a ROM, RAM, an input/output port, a communication port, and the like. The electronic control unit ECU drives and controls the motor MG and the charger CH. When the temperature Tb of the battery B is equal to or higher than the threshold (limit threshold) Tbref, the electronic control unit ECU controls the charger CH so that the charge/discharge power of the battery B is limited.

The charging device 20 includes a charging cable 22 including a charging connector 21, an AC/DC converter 24, a display device 26, and a control device 28.

The charging cable 22 includes a power line for supplying electric power and a communication line for exchanging information.

AC/DC converter 24 converts AC power supplied from the power system 30 via the distribution board 32 into DC power and supplies the DC power to the charging cable 22, and AC/DC converter 24 is controlled by the control device 28.

The display device 26 is configured as a touch panel type display, and displays various kinds of information. The display device 26 is controlled by the control device 28.

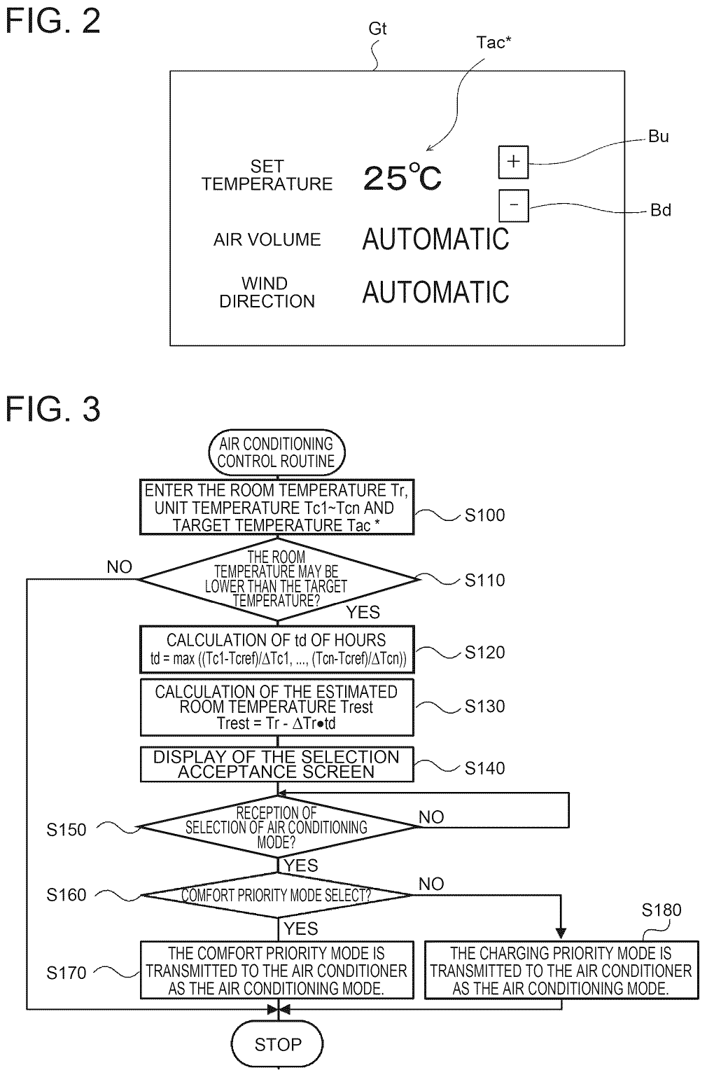

The control device 28 includes a computer (not shown) having a CPU, a ROM,RAM, an input/output port, a communication port, and the like. The control device 28, the device temperature Tc1 to Ten from the temperature sensor S1 to Sn which detects the temperature of the charging device 20 is attached to the n locations of the charging device 20 (n is an integer of a value 1 or more) is inputted. When the charging connector 21 is inserted into the charging inlet I of the vehicle V, the control device 28 exchanges information with the electronic control unit ECU of the vehicle V via the communication line of the charging cable 22. The information to be exchanged includes, for example, the following information: the battery current from the current sensor that detects the charge/discharge current of the battery B, the battery voltage from the voltage sensor that detects the voltage between the terminals of the battery B, and the information on the status of the battery B, such as the temperature Tb of the battery B. The control device 28 controls AC/DC converter 24 based on the battery current received via the charging cable 22 and the voltage between terminals of the battery B, and supplies electric power to the charging cable 22. The control device 28 controls the display device 26 so that various kinds of information are displayed to the user U during a break in the container cabin C while the battery B of the vehicle V is being charged. The information displayed on the display device 26 includes a guidance for use of the charging device 20, a guidance for paying (charging) a charging fee using cash or a credit card, and a guidance for setting a target temperature Tac* of the air-conditioning device 40. FIG. 2 is an explanatory diagram illustrating an exemplary temperature setting window Gt displayed on the display device 26. The temperature setting window Gt is a screen for receiving the setting of the target temperature Tac*, and a set temperature Tac, a button Bu, and a button Bd are displayed. The button Bu is a display for increasing the target temperature Tac*, and rises by one degree each time the button Bu is pressed by the user U or the like. The button Bd is a display for lowering the target temperature Tac*, and is lowered by one degree each time the button Bu is pressed by the user U or the like. The user U can set the target temperature Tac* of the air-conditioning device 40 via the temperature setting window Gt. The control device 28 transmits the set target temperature Tac* to the air-conditioning device 40.

The air-conditioning device 40 is configured as a device that performs air-conditioning in the container cabin C including a compressor (not shown) or the like, and is operated by electric power supplied from the power system 30 via the distribution board 32. The air-conditioning device 40 includes an air-conditioning control device 42 having a computer (not shown) having a CPU, a ROM,RAM, an input/output port, a communication port, and the like. The air-conditioning control device 42 receives the room temperature Tr from the temperature sensor 44 that detects the temperature in the container cabin C. The air-conditioning control device 42 exchanges various kinds of information necessary for air-conditioning in the container cabin C with the control device 28 of the charging device 20 by wired or wireless communication. Examples of the data exchanged from the control device 28 of the charging device 20 include a target temperature Tac*. The air-conditioning control device 42 controls the compressor or the like so that the room temperature Tr becomes the target temperature Tac*, which is received from the control device 28.

In the charging system 1 configured as described above, when the charging connector 21 is inserted into the charging inlet I of the vehicle V, the control device 28 executes external charging control for controlling the charging device 20 so as to charge the battery B with electric power from the charging device 20. When at least one of the device temperatures Tc1 to Ten from the temperature sensor S1 to Sn is equal to or higher than the threshold Tcref1 during the external charge control, the maximal cooling control is executed. Further, during the external charge control, the maximum cooling control may be executed when a temperature excess flag signal indicating that at least one of the device temperatures Tc1 to Ten is equal to or higher than the threshold Tcref1 is inputted. In the maximum cooling control, the air-conditioning device 40 is cooled and operated at a maximum output which is a maximum value of electric power that can be output during cooling. In the maximum cooling control, the control device 28 transmits a maximum cooling command to the air-conditioning device 40. The air-conditioning control device 42 of the air-conditioning device 40 that has received the maximum cooling command controls a compressor or the like so that the air-conditioning device 40 performs cooling operation at the maximum output at the time of cooling. Accordingly, the temperature in the container cabin C is rapidly lowered to cool the charging device 20. The control device 28 executes the charge limit control when at least one of the device temperatures Tc1 to Ten is equal to or higher than the threshold Tcref1 or when the temperature excess flag signal is inputted even after a predetermined period of tref has elapsed from the beginning of the execution of the maximum cooling control. In the charge limit control, the charging device 20 is controlled so that the electric power supplied to the battery B is limited, and the heat generation of the charging device 20 is suppressed. Thus, the temperature rise of the charging device 20 is suppressed.

Next, the operation of the charging system 1 configured in this way, in particular, the operation during the external charging control will be described. FIG. 3 is a flowchart illustrating an example of an air-conditioning control routine executed by the control device 28 of the charging device 20. This routine is executed immediately after the execution of the maximum cooling control is started during the external charging control.

When the execution of this routine is started, CPU of the control device 28 executes a process of inputting the room temperature Tr from the temperature sensor 44, the device temperature Tc1 to Ten from the temperature sensor S1 to Sn, and the target temperature Tac* (S100). Then, if the maximal cooling control is continued, it is determined whether or not there is a possibility that the temperature (room temperature) in the container cabin C is lower than the target temperature Tac* (S110). This determination, when the difference between the temperature and the target temperature Tac* in the container cabin C when the maximum cooling control is started is less than the predetermined temperature difference ΔT, it is determined that there is a possibility that the temperature in the container cabin C is lower than the target temperature Tac* when the maximum cooling control is continued. The temperature in the container cabin C when the maximal cooling control is started is the room temperature Tr entered by S100. The predetermined temperature-difference ΔT is set in advance based on an experiment, an analysis, a machine-learning, or the like, and is stored in ROM. When the maximum cooling control is continued, when there is no possibility that the room temperature is lower than the target temperature Tac*, even if the maximum cooling control is continued, it is determined that there is no possibility that the comfort of the user is impaired, and the routine ends. In this case, the execution of the maximum cooling control is continued. As a result, the temperature rise of the charging device 20 is suppressed.

Continuing the maximum cooling control at S110 may compromise the user's comfort when the room temperature may be lower than the target temperature Tac*. Therefore, a time td from when the maximum-cooling control is started until all of the device temperature Tc1 to Ten become less than the threshold Tcref1 is calculated (S120). The time td is calculated by the following equation (1) as the largest value among the values obtained by dividing the device temperature Tc1 to Ten at the time of starting the maximum cooling control by the temperature decrease amounts ΔTc1 to ΔTcn of the charging device 20 per unit time when the battery B is charged at the predetermined power Wref during the maximum cooling control. The device temperature Tc1 to Ten when the maximum-cooling control is started is obtained by subtracting the device temperature Tc1 to Ten inputted by S100 from the threshold Tcref. The temperature-lowering amounts ΔTc1 to ΔTcn are set in advance based on experimentation, analysis, machine-learning, and the like, and are stored in ROM. Then, to calculate the estimated room temperature Trest as an estimated value of the room temperature when the time td has elapsed after starting the maximal cooling control (S130). Calculation of the estimated room temperature Trest, the temperature in the container cabin C when the maximum cooling control is started, that is, the room temperature Tr inputted in S100, the room temperature drop per unit time ΔTr at the time of the maximum cooling control, and the time td, is calculated by the following equation (2). The room temperature decrease ΔTr is set in advance based on experimentation, analysis, machine-learning, and the like, and is stored in ROM.

$$t d = max ( ( Tc 1 - Tcref ) / Δ Tc 1 , ( Tc 2 - T cref ) / Δ Tc 2 , … , ( T cn - Tcref ) / Δ Tcn ) \qquad ( 1 )$$

$$Trest = Tr - Δ Tr \cdot td \qquad ( 2 )$$

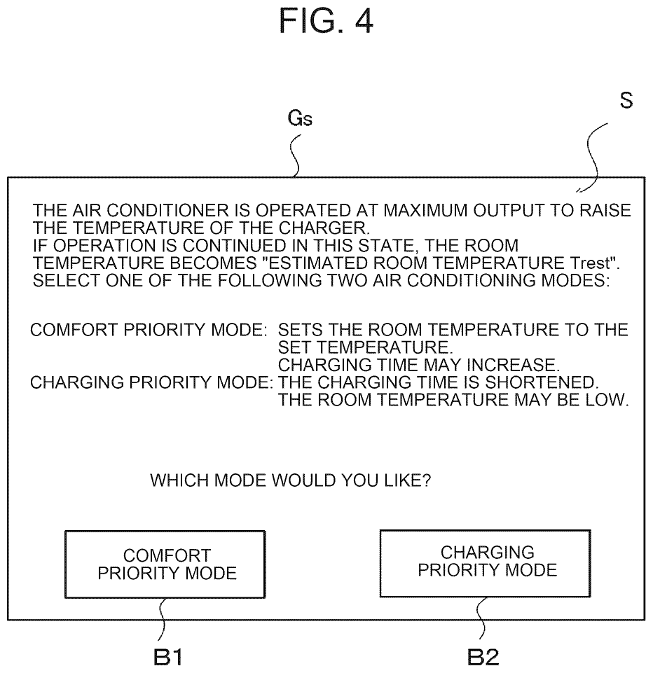

Subsequently, a selection reception window Gs is displayed on the display device 26 (S140). FIG. 4 is an explanatory diagram illustrating an exemplary of a selection reception window Gs. The selection reception window Gs is a screen for displaying the estimated room temperature Test and prompting the user U to select the air-conditioning mode of the air-conditioning device 40. The selection reception window Gs displays the explanatory sentence S of the comfort priority mode (first air-conditioning mode) and the charge priority mode (second air-conditioning mode), which are two air-conditioning modes that include the estimated room temperature Test and can be selected, and the select button B1, B2. The comfort priority mode is an air-conditioning mode in which the room temperature of the container cabin C is set to a temperature that prioritizes the comfort of the user U in the container cabin C over the charging time of the battery B by the charging device 20. The charging priority mode is an air-conditioning mode in which the temperature is set as a temperature that prioritizes the charging time of the battery B over the comfort. The select button B1 is for selecting the comfort priority mode, and receives selection of the comfort priority mode by pressing a select button B1 by the user U or the like. The select button B2 is an indication for selecting the charging priority mode, and receives selection of the air-conditioning mode of the charging priority mode by pressing the select button B2 by the user U or the like. Since the estimated room temperature Test is displayed on the selection reception window Gs, the user can select the air-conditioning mode after recognizing the estimated room temperature Test.

When the selection reception window Gs is displayed in this way, the select button B1 or the select button B2 is pressed and waited until the selection of the air-conditioning mode is received (S150). When the selection of the air-conditioning mode is received, it is determined whether or not the received air-conditioning mode is the comfort-first mode (S160). When the received air-conditioning mode is the comfort priority mode, the comfort priority mode is transmitted as the air-conditioning mode to the air-conditioning device 40 (S170), and the routine ends. The air-conditioning control device 42 of the air-conditioning device 40 that has received the comfort priority mode as the air-conditioning mode controls the compressor or the like so that the room temperature becomes the target temperature Tac* received from the control device 28. In the comfort priority mode, the room temperature is set to a temperature at which the comfort of the user U is prioritized over the charging time of the battery B by the charging device 20. Therefore, in the comfort priority mode, the temperature of the charging device 20 may increase, and the charging time of the battery B may be prolonged due to the limitation of the electric power supplied from the charging device 20 to the battery B. The temperature in the container cabin C can be set to a desired temperature of the user U, and a comfortable environment can be provided to the user U in the container cabin C. Accordingly, it is possible to suppress a decrease in convenience of the user.

When the air-conditioning mode received by S150 is the charging-priority mode, the charging mode is transmitted to the air-conditioning device 40 as the air-conditioning mode (S180), and the routine ends. The air-conditioning control device 42 of the air-conditioning device 40 that has received the charge-priority mode as the air-conditioning mode controls the compressor or the like so that the temperature in the room becomes a temperature Tcc (for example, a temperature lower than the threshold Tcref1 by a decrease ΔTcr (for example, 5° C.) or the like). In this case, although the comfort of the user U in the container cabin C is reduced, the temperature rise of the charging device 20 can be suppressed, and the charging time of the battery B can be suppressed from being prolonged due to the limitation of the electric power supplied from the charging device 20 to the battery B. In this way, by displaying the selection reception window Gs and receiving the selection of the air-conditioning mode from the user U, it is possible to suppress the decrease in the convenience of the user.

According to the charging system 1 of the present embodiment described above, the selection of the air-conditioning mode of either the comfort priority mode or the charging priority mode is received via the selection reception window Gs. In the comfort priority mode, the temperature in the container cabin is a temperature that prioritizes the comfort of the user U in the container cabin over the charging time of the battery B by the charging device 20. In the charging priority mode, the temperature in the container cabin is a temperature that prioritizes the charging time of the battery B over the comfort. The air-conditioning device 40 is installed in the container cabin together with the charging device 20, and performs indoor air-conditioning in the air-conditioning mode selected by the selection reception window Gs, so that it is possible to suppress a decrease in convenience of the user.

Further, by receiving the setting of the target temperature Tac* via the temperature setting window Gt, it is possible to suppress a decrease in convenience of the user. In the comfort priority mode, the temperature in the room is set to be the target temperature Tac*, whereby the temperature in the room is set to be the temperature that prioritizes the comfort over the charge time. In the charge priority mode, the temperature in the room is set to be less than the threshold Tcref1, and thus the temperature in the room is set to be a temperature in which the charge time is prioritized over the comfort. Accordingly, it is possible to suppress a decrease in convenience of the user.

Further, a display device 26 for notifying information is provided, and when it is estimated that the room temperature Tr is less than the target temperature Tac*, the user U can be prompted to select the air-conditioning mode by displaying the selection reception window Gs on the display device 26.

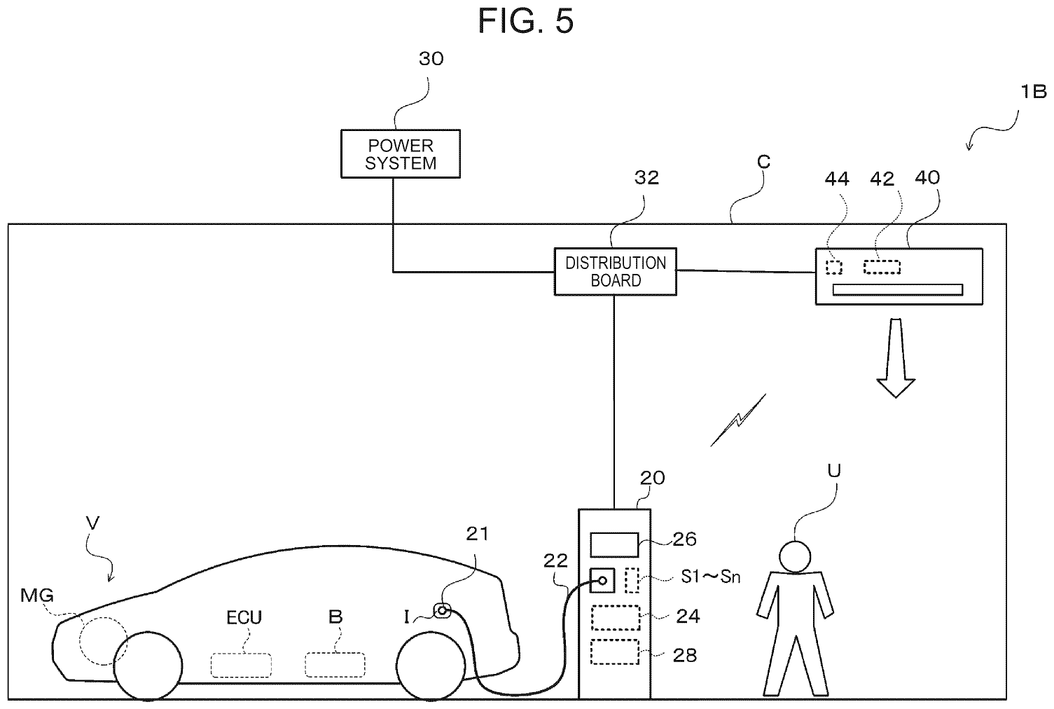

In the above-described embodiment, the vehicle V is parked outside the container cabin C. However, as illustrated in 1B of FIG. 5, the vehicle may be parked in the container cabin C. In this case, the control device 28 of the charging device 20 may display the selection reception window Gs on the display device 26 when the predetermined condition is satisfied. The predetermined condition is a condition in which it is estimated that the charging of the battery B is limited by the temperature increase of the battery B from the vehicle V via the charging cable 22. Examples of the predetermined condition include a condition in which the temperature Tb of the battery B inputted from the vehicle V via the charging cable 22 is equal to or higher than the threshold Tbref. As another predetermined condition, a condition in which the power of the charging device 20 charging the battery B is less than the threshold Pcref is continued for a predetermined time or longer, and the like can be exemplified. The threshold value Pcref is a threshold value for determining whether or not the charge of the battery B is limited in the vehicle V. In this case, as the selection reception window Gs, it may be displayed in the explanatory sentence S that there is a possibility that the temperature of the battery B of the vehicle V is high instead of the estimated room temperature Test. In this way, when the vehicle V is parked in the container cabin C and it is estimated that the charging of the battery B is limited by the temperature increase of the battery B in the vehicle V, the user can be prompted to select the air-conditioning mode via the selection reception window Gs.

In the above-described embodiment, when there is a possibility that the temperature in the container cabin C is lower than the target temperature Tac*, the selection reception window Gs is displayed on the display device 26. However, in a case where the charging device 20 includes a notification device for notifying information different from the display device 26 such as a speaker, the notification device may be caused to execute notification for prompting the user U to select the air-conditioning mode.

In the above-described embodiment, the display device 26 is installed in the charging device 20. However, the display device 26 may be set at any position visible to the user U, such as a wall surface inside the container cabin C.

The correspondence between the main elements of the embodiments and the main elements of the disclosure described in the column of the means for solving the problem will be described. In the embodiment, the charging device 20 corresponds to the “charging device”, the control device 28 corresponds to the “control device”, the control device 28 corresponds to the “selection device”, and the air-conditioning device 40 corresponds to the “air-conditioning device”.

The correspondence between the main elements of the embodiment and the main elements of the disclosure described in the section of the means for solving the problem is an example for specifically explaining the embodiment of the disclosure described in the section of the means for solving the problem. The correspondence between the main elements of the embodiments and the main elements of the disclosure is not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a charging system and the like.

What is claimed is:

1. A charging system including a charging device that charges a battery mounted on a vehicle and is installed in a room, and a control device that controls the charging device such that electric power supplied to the battery is limited when a temperature of the charging device becomes equal to or higher than a threshold value, the charging system comprising:
a selection device that receives selection of any one of a first air-conditioning mode in which a temperature inside the room is set to a temperature that prioritizes comfort of a user in the room over a charging time for the battery with the charging device, and a second air-conditioning mode in which the temperature inside the room is set to a temperature that prioritizes the charging time over the comfort; and
an air-conditioning device that is installed in the room together with the charging device and air-conditions an inside of the room in the air-conditioning mode selected by the selection device.

2. The charging system according to claim 1, the charging system further comprising
a temperature setting device that receives setting of a target temperature, wherein
in the first air-conditioning mode, by setting the temperature inside the room to the target temperature, the temperature inside the room is set to the temperature that prioritizes the comfort over the charging time, and
in the second air-conditioning mode, by setting the temperature inside the room to be less than the threshold value, the temperature inside the room is set to the temperature that prioritizes the charging time over the comfort.

3. The charging system according to claim 2, the charging system further comprising
a notification device that provides notification of information, wherein
when the temperature inside the room is estimated to become less than the target temperature, the control device controls the notification device such that notification is issued to prompt selection of the air-conditioning mode by the selection device.

4. The charging system according to claim 1, the charging system further comprising
a notification device that provides notification of information, wherein
in a case where the vehicle is parked in the room, the control device controls the notification device such that notification is issued to prompt selection of the air-conditioning mode by the selection device when a predetermined condition is satisfied in which the charging of the battery is estimated to be limited due to temperature rise of the battery in the vehicle.
